(19) United States
(12) Patent Application Publication
(10) Pub. No.: US 2018/0216600 A1
(43) Pub. Date: Aug. 2, 2018

(54) Noise Reducing Fence for a Wind Turbine Blade

(71) Applicant: Siemens Aktiengesellschaft, München (DE)

(72) Inventor: Alonso O. Zamora Rodriguez, Broomfield, CO (US)

(21) Appl. No.: 15/747,524

(22) PCT Filed: Sep. 10, 2015
(86) PCT No.: PCT/US2015/049319

§ 371 Date: Jan. 25, 2018

(51) Int. Cl. F03D 1/06

(52) U.S. Cl. CPC F03D 1/0633; F05B 2260/96; F05B 2240/30; F05B 2240/221

(57) ABSTRACT

A noise reducing wind turbine blade is disclosed. The wind turbine blade includes a blade body having a leading edge, a trailing edge, a suction side, and a pressure side. The wind turbine blade further includes a fence disposed on a portion of the blade body upstream from the trailing edge for modifying airflow over the blade body in the vicinity of the trailing edge effective to reduce acoustic emission.

### BACKGROUND

### 1. Field

The invention relates to noise reduction devices on airfoils, and particularly to noise reduction fences on wind turbine blades

### 2. Description of the Related Art

Undesirable aerodynamic noise is generated by a wind turbine blade when turbulent eddies in the boundary layer of air flowing over the blade pass over the blade trailing edge. These eddies interact with the trailing edge to form acoustic pressure waves perceived as audible noise. Noise reducers, such as add-on serrated tooth structures extending away from the trailing edge and aligned with the chord-wise airflow off the blade, have been used to reduce aerodynamic noise. Although such trailing edge modifications have been effective, there continues to be a need in the wind turbine industry to further reduce aerodynamic noise to meet regulations, minimize site objections, and enable larger rotors.

### SUMMARY

Briefly described, aspects of the present invention relate to reducing noise generated by wind turbine blades.

A first aspect of the invention provides a wind turbine blade comprising a blade body having a leading edge, a trailing edge, a suction side, and a pressure side. The wind turbine blade further comprises a fence disposed on a portion of the blade body upstream from the trailing edge for modifying airflow over the blade body in the vicinity of the trailing edge effective to reduce acoustic emission.

A second aspect of the invention provides a noise reducer for a wind turbine blade comprising a fence for attachment to a portion of a wind turbine blade upstream from a trailing edge of the blade. The fence comprises airflow modifying structures configured to extend at least partially into a boundary layer of airflow over the blade upstream of the trailing edge effective to reduce acoustic emissions.

A third aspect of the invention provides a wind turbine comprising at least one blade having a leading edge, a trailing edge, a suction side, and a pressure side. The wind turbine blade further comprises a fence disposed on a portion of the blade body upstream from the trailing edge for modifying airflow over the blade body in the vicinity of the trailing edge effective to reduce acoustic emission.

### BRIEF DESCRIPTION OF THE DRAWINGS

FIG. 1 is a perspective view of a wind turbine blade according to an embodiment of the invention.

FIG. 2 is a chord-wise cross section of the blade of FIG. 1 viewed along line 2-2 and indicating eddy formation at the trailing edge.

FIG. 3 is a chord-wise cross section of the blade of FIG. 1 viewed along line 2-2 and indicating acoustic wave propagation directed upstream from the trailing edge.

FIG. 4 is a chord-wise cross section of the blade of FIG. 1 viewed along line 4-4 showing example noise reducers installed on a pressure and a suction side upstream of the trailing edge.

FIGS. 5A-D are various example configurations for a noise reducer for use with the wind turbine blade 10 shown in FIG. 1.

FIG. 6 is side view of noise reducer for use with the wind turbine blade 10 shown in FIG. 1 having various example configurations of passageways there through.

FIG. 7 is partial perspective view of a noise reducer for use with the wind turbine blade 10 shown in FIG. 1 having serrated tooth noise reduction appendages.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

In the wind turbine industry, conventional noise reduction techniques have focused on airflow-aligned trailing edge appendages to attenuate and/or redirect acoustic pressure waves formed at the discontinuity of the trailing edge. Noise reducing structures, such as serrated “teeth,” extending chord-wise from the trailing edge, have been used to accomplish some degree of noise attenuation. In contrast to this conventional wisdom of using noise reducing devices extending away from the trailing edges, the present inventor has innovatively realized that noise reducers in the form of a porous wall or fence may be effectively applied along a portion of the blade upstream of the trailing edge, either alone or in conjunction with serrated teeth, to reduce blade noise.

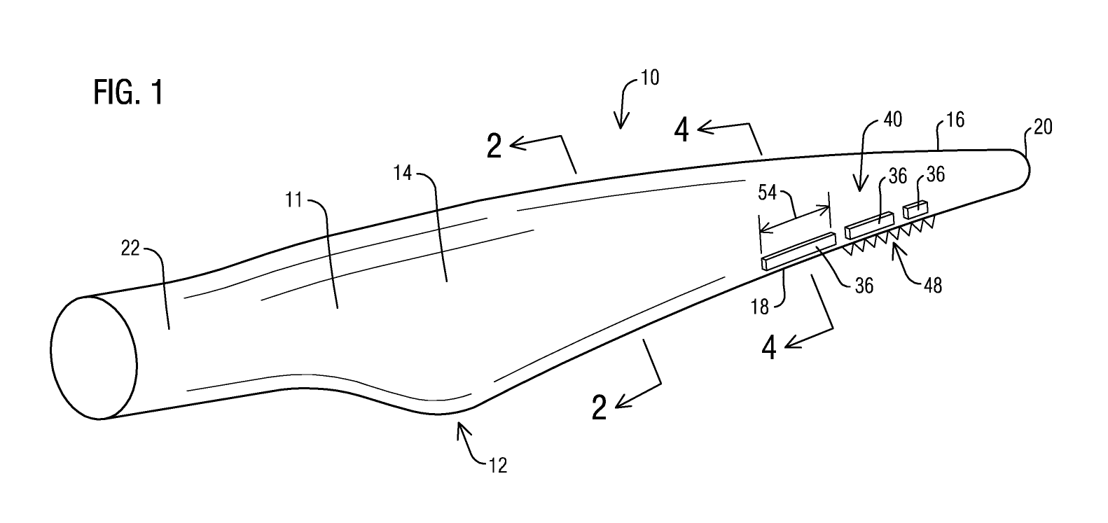

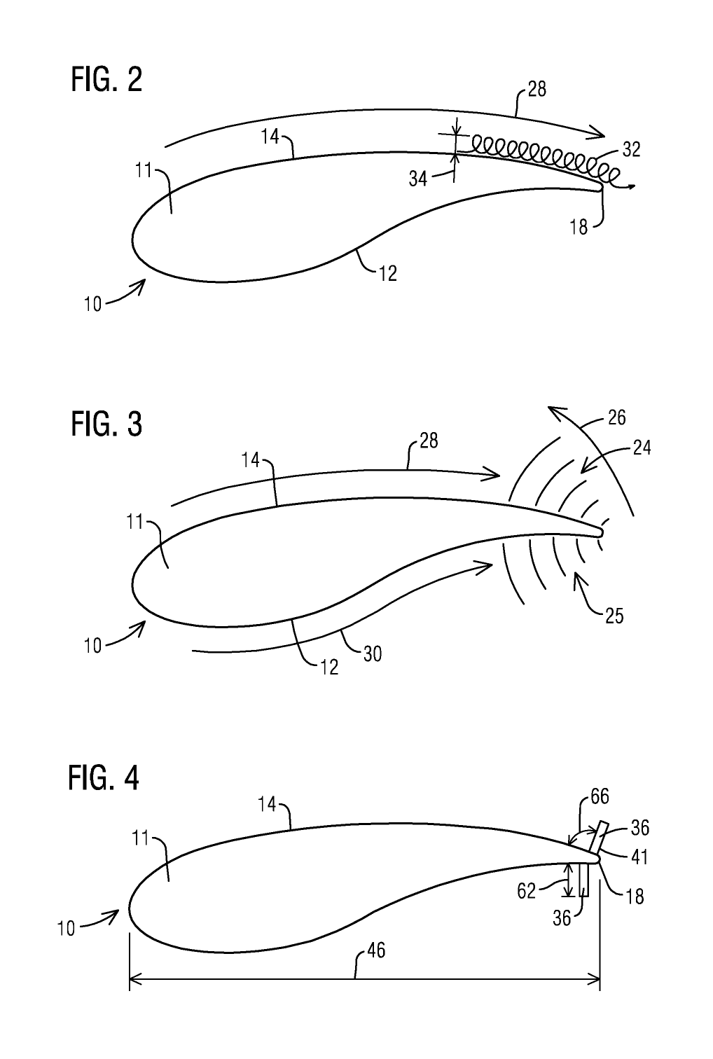

FIG. 1 shows a wind turbine blade 10 having a pressure side 12 and a suction side 14 extending chord-wise between a leading edge 16 and a trailing edge 18. The blade 10 extends longitudinally from a blade tip 20 to a blade root 22. FIG. 2 shows a chord-wise cross section of the blade 10 taken at section 2-2. As the blade 10 moves through the air, turbulent eddies 32 form in a boundary layer 34 attached to the pressure side 12 and suction side 14 of the blade 10. These eddies 32 interact with the trailing edge 18 to generate scattering that propagates acoustic pressure waves. FIG. 3 shows the acoustic pressure waves 24, 25 propagating in an upstream direction 26 from the trailing edge 18 opposite to the airflows 28, 30 over the pressure side 12 and the suction side 14. The inventor has recognized that these acoustic pressure waves 24, 25 are a significant source of acoustic noise generated by the blade 10 as it moves through the air.

In an embodiment of the invention depicted in FIG. 1 and FIG. 4, the blade 10 includes a blade body 11 having a porous wall or fence 36 disposed on a portion 40 of the blade body 11 upstream from the trailing edge 18. The fence 36 modifies the airflow 28 over the blade body 11 to reduce acoustic emission. The fence 36 functions to induce weaker scattering at the trailing edge 18 and to produce scattering that interacts with the trailing edge scattering to weaken acoustic pressure waves 24, 25. In another aspect, the fence 36 functions to induce a shift from lower frequency energy levels to higher frequencies that are attenuated more efficiently in the atmosphere before reaching ground level. For example, the fence 36 promotes the formation of smaller flow structures that create high frequency acoustic noise that is easily attenuated by the atmosphere. The fence 36 may be disposed on the suction side 14, the pressure side 12, or both the suction side 14 and the pressure side 12. The fence 36 may extend continuously over length 54 or intermittently along at least a portion of a longitudinal length of the blade body 11 near the trailing edge 18. In an embodiment, a downstream edge 41 of the fence 36 may be disposed adjacent the trailing edge 18. In yet another embodiment, the fence 36, or part of it, may incorporate or function as lightning receptors.

The fence 36 may be a separately fabricated piece attached to the blade body 11 or may be formed integrally with the blade body 11. The fence 36 may be relatively rigid, or may be flexible to adapt to an angle of incidence of the airflow 28. For example, the fence 36 may be made of a flexible material or be moveably attached to the blade body 11, such as by a hinge. As shown in FIG. 4, the fence 36 may extend vertically away for the blade body 11 at an angle 66 of about 90 degrees, or may be inclined to extend vertically away from the blade body 11 at an angle of between about 50 and 140 degrees.

In the example embodiment shown in FIG. 4, the fence 36 may comprise a height 62 of between about 0.1% to 5% of a local chord length 46. In another embodiment, the fence 36 may comprise a height 62 of between about 0.1% and 1.0% of a local chord length 46. The height 62 may be selected according to a desired level of noise reduction, while minimizing adverse blade aerodynamics. Different height 62 may be used at different locations along the blade body 11, and the height 62 of a fence 36 may be variable. While exemplary dimensions are provided, it is understood that such dimensions are for illustrative purposes only, and that greater or lesser dimensions for height 62 and/or length 54 of the fence 36 may be employed in other embodiments. For example, since the chord length 46 changes along the longitudinal length of the blade 10, the height 62 as a percentage of chord length 46 may be a larger percentage of the chord length 46 near the tip 20 and a comparatively smaller percentage of the chord length 46 nearer the root 22.

In blades 10 that have noise reducing trailing edge 18 appendages such as serrated teeth 48 shown in FIG. 1 and FIG. 7, the fence 36 may be disposed upstream of the serrated teeth 48. The fence 36 may extend continuously with respect to the serrated teeth 48, or may be discontinuous corresponding to certain features of the teeth 48. As shown in FIG. 7, the fence 36 may be disposed upstream of a valley 50 between downstream points 52 of the serrated teeth 48. In an embodiment, a length 54 of the fence 36 may be less than a distance 60 between points 52 of the teeth 54. For example, gaps 56, 58 on either side of the fence 36 relative to chord-wise centrelines of respective points 52 may about 10% to 100% of a height of the fence 36.

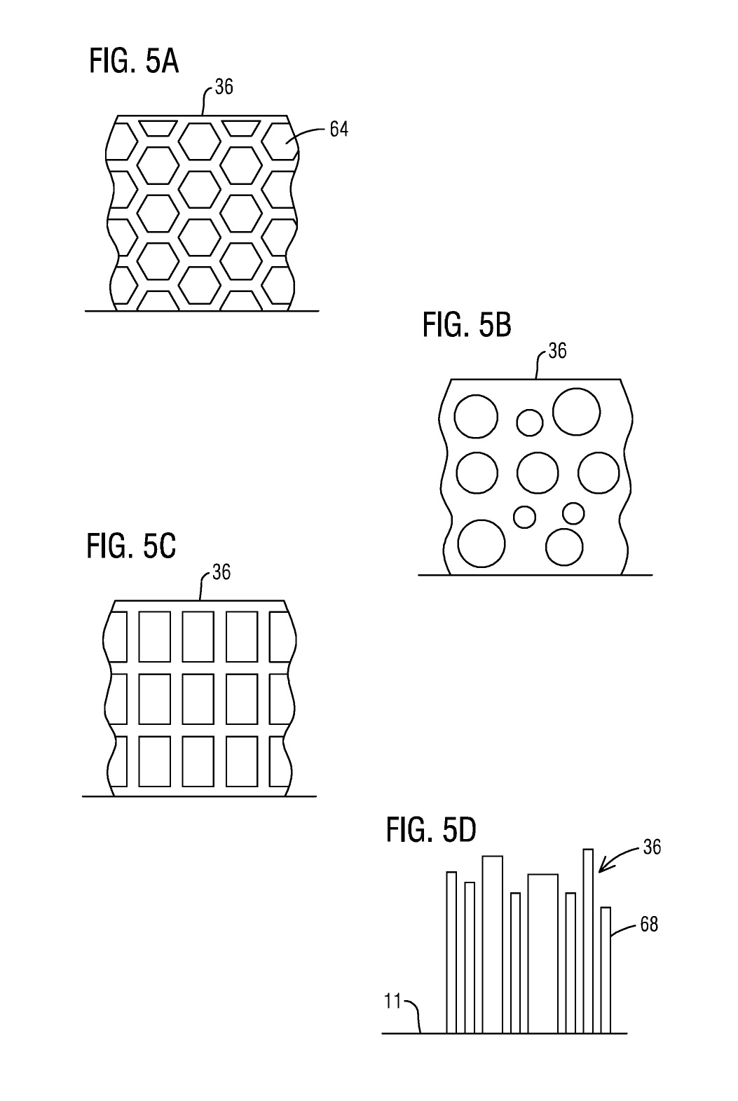

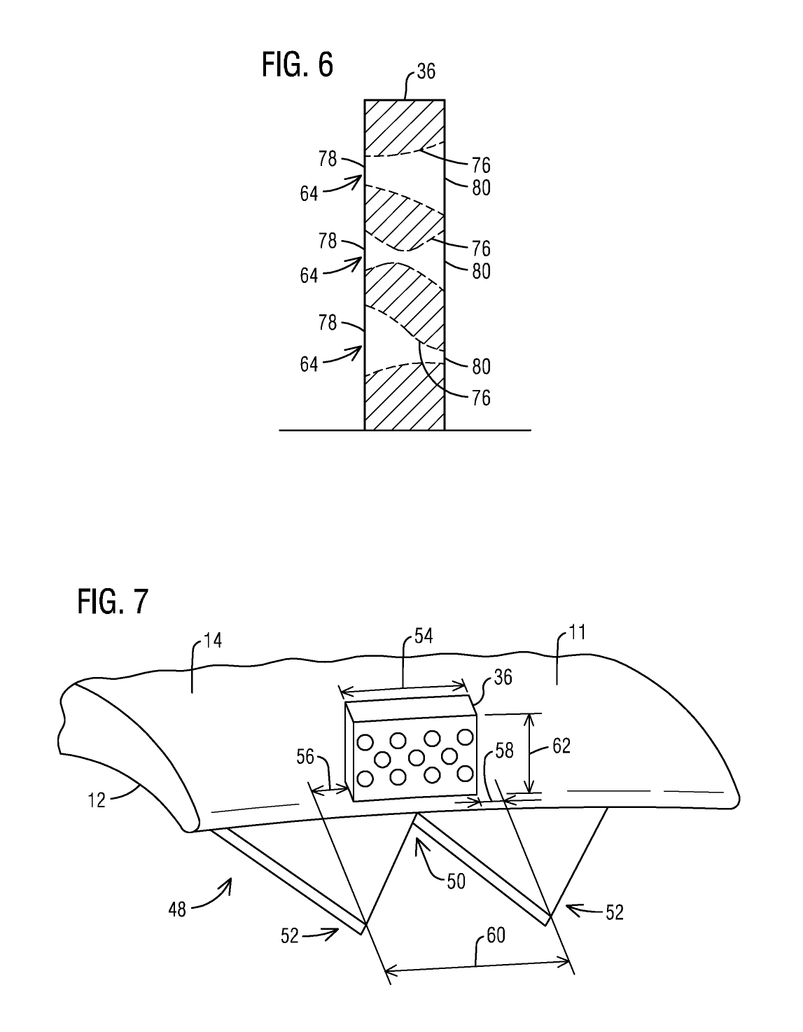

The fence 36 is porous for allowing airflow therethrough. In an embodiment, the fence 36 may have a porosity of between about 50% and 90%, and in another embodiment, a porosity of between about 70% and 90%. As shown in FIGS. 5A-5C, the fence 36 may have perforations or passageways 64 extending therethrough to provide a desired porosity. The passageways 64 may be substantially aligned with the airflow 28. The passageways 64 may have one or more of a circular, polygonal, or rectilinear cross section, such as a mesh or netting, or a combination of different shaped crossed sections. In an embodiment shown in FIG. 5A, the passageways 64 may include a honeycomb configuration. The passageways 64 may be configured to substantially maintain an air flow velocity through the fence 36. For example, at least some of the passageways 64 may have a diverging profile 76 wherein an inlet 78 is smaller than an outlet 80. In another embodiment, at least some of the passageways 64 may have a converging profile 76 wherein an outlet 80 is smaller than an inlet 78. A profile 76 may take any shape within the fence 36 to achieve a desired aerodynamic affect.

In another embodiment shown in FIG. 5D, the fence 36 may include a row of bristles 68. The bristles 68 may have various lengths, shapes, diameters, and orientation angles with respect to the blade body 11. In an embodiment, at least a portion of the bristles 68 may be aligned in a blade longitudinal direction along the trailing edge 18.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

What is claimed is:

1) A wind turbine blade comprising:
a blade body having a leading edge, a trailing edge, a suction side, and a pressure side; and
a fence disposed on a portion of the blade body upstream from the trailing edge for modifying airflow over the blade body in the vicinity of the trailing edge effective to reduce acoustic emission.

2) The wind turbine blade of claim 1, wherein the fence is disposed adjacent the trailing edge.

3) The wind turbine blade of claim 1, further comprising a serrated tooth trailing edge appendage, wherein the fence is disposed along at least a portion of the trailing edge upstream of the serrated tooth trailing edge appendage.

4) The wind turbine blade of claim 4, where the fence is disposed upstream of a valley between downstream points of the serrated teeth.

5) The wind turbine blade of claim 4, where a length of the fence is less than a distance between downstream points of the serrated teeth.

6) The wind turbine blade of claim 1, wherein the fence comprises a porosity of between about 50% and 90%.

7) The wind turbine blade of claim 1, wherein the fence comprises a porosity of between about 70% and 90%.

8) The wind turbine blade of claim 1, wherein the fence comprises a plurality of passageways substantially aligned with the airflow.

9) The wind turbine blade of claim 8, wherein the passageways comprise one or more of a circular, polygonal, or rectilinear cross section.

10) The wind turbine blade of claim 8, wherein the passageways are configured to substantially maintain an air flow velocity through the fence.

11) The wind turbine blade of claim 10, wherein at least some of the passageways comprise an inlet smaller than an outlet.

12) The wind turbine blade of claim 10, wherein at least some of the passageways comprise an outlet smaller than an inlet.

13) The wind turbine of claim 1, wherein the fence comprises a row of bristles.

14) The wind turbine of claim 1, wherein the fence extends vertically away from the blade body at an angle of between 50 and 140 degrees.

15) The wind turbine of claim 1, wherein fence extends vertically away from the blade body at an angle of about 90 degrees.

16) The wind turbine of claim 1, wherein the fence is configured to flexibly adapt to an angle of incidence of the airflow.

17) The wind turbine blade of claim 1, wherein the fence comprises a height of between about 0.1% to 5% of a local chord length.

18) The wind turbine blade of claim 1, wherein the fence comprises a height of between about 0.1% and 1.0% of a local chord length.

19) The wind turbine blade of claim 1, wherein the fence is disposed on the suction side, the pressure side, or both the suction and pressure side.

20) The wind turbine blade of claim 1, wherein the fence comprises a lightning receptor.

21) A noise reducer for a wind turbine blade comprising:
a fence for attachment to a portion of a wind turbine blade upstream from a trailing edge of the blade;
wherein the fence comprises airflow modifying structures configured to extend at least partially into a boundary layer of airflow over the blade upstream of the trailing edge effective to reduce acoustic emissions.

22) A wind turbine comprising:
at least one blade having a leading edge, a trailing edge, a suction side, and a pressure side; and
a fence disposed on a portion of the blade body upstream from the trailing edge for modifying airflow over the blade body in the vicinity of the trailing edge effective to reduce acoustic emission.
